(19) United States
(12) Patent Application Publication
(10) Pub. No.: US 2008/0180352 A1
(43) Pub. Date: Jul. 31, 2008

(54) System and Method for Distributing a Multimedia Message Using a Wearable Multimedia Display

(75) Inventors: Milad Modir, Brampton (CA); Jamil Jacek Haidairi, Vaughan (CA); Jing Bia, YangZhou (CN)

Correspondence Address: DUANE MORRIS, LLP;IP DEPARTMENT, 30 SOUTH 17TH STREET, PHILADELPHIA, PA, 19103-4196, US

(73) Assignee: The Advertising Group of Technology Inc., Toronto (CA)

(21) Appl. No.: 11/965,196

(22) Filed: Dec. 27, 2007

Related U.S. Application Data
(63) Continuation-in-part of application No. 11/838,401, filed on Aug. 14, 2007, now abandoned.

(30) Foreign Application Priority Data
Dec. 29, 2006 (CA) 2572933

(51) Int. Cl. G09G 5/00

(52) U.S. Cl. 345/8

(57) ABSTRACT

A wearable multimedia display is described having a processor connected to a display panel adequate for displaying multimedia content. The processor is also connected to a source of multimedia content that can be displayed on the display panel. The use of the wearable multimedia display allows for a method of distributing a multimedia message to those in the vicinity of the wearer. The wearable multimedia display provides for an efficient and non-intrusive means of delivering a message, such as advertisements or information.

This application is a continuation-in-part of U.S. application Ser. No. 11/838,401, filed Aug. 14, 2007, the entire contents of which is hereby incorporated by reference.

The section headings used herein are for organizational purposes only and are not to be construed as limiting the described subject matter in any way.

### TECHNICAL FIELD

The present invention relates to a method and apparatus for distributing a multimedia message to provide information or promotional material to the public.

### BACKGROUND

When people interact with one another there is an opportunity to convey a message by wearing an article displaying the message. For example, in the retail sales context, a salesperson may wear a tag displaying their name, and possibly the name of the store or any current sales promotions. A person interacting with the salesperson will be able to view this additional information on the tag worn by the salesperson. However, by presenting a static message on the tag this opportunity is limited to one message. It is also expensive to continually produce new tags to reflect current information or promotions. Furthermore, in low light environments it is difficult to read the information.

### SUMMARY

The present invention relates to a method and apparatus for distributing a multimedia message to provide information or promotional material to the public. The multimedia message can be in the form of, for example, but not limited to, a video, an image, or a slideshow of images.

A wearable multimedia display is an efficient and non-intrusive way to deliver a message. The use of multimedia content on the display can maximize the interaction between people by creating another channel to deliver a number of messages. People in view of the display can observe the messages and receive additional information that may otherwise not have been discovered through conversation. By using a light emissive display the wearable multimedia display will be highly visible, even in low light environments.

The use of a wearable multimedia display may be used to display information the person may have forgot to mention, and also to create awareness or interest in a product or brand. The wearable multimedia display may be used as a marketing tool or for informational/educational purposes. The wearable multimedia display creates opportunities to promote add-on products or services, to up-sell to an upgraded product or service, or to cross-sell a complimentary product. The wearable multimedia display may also be used for affiliate marketing or to generate ad revenue by selling advertising space.

According to one aspect of the present application, there is provided a wearable multimedia display. The wearable multimedia display includes a display panel for displaying multimedia content, a processor, connected to the display panel, the processor to control the display of multimedia content from a source of multimedia content, and a means for attaching the display to a wearer.

According to another aspect of the present application, there is provided a system for displaying a multimedia message on a wearable display. The system includes a source of multimedia content, a wearable display device have a display panel and a communications interface connected to the source of multimedia content, and a processor connected to the display panel to control the display of the multimedia content.

According to still another aspect of the present application, a method of displaying a multimedia message on a wearable display is provided. Method includes receiving multimedia content from a source of multimedia content and displaying the multimedia content on a display panel so that the multimedia content is accessible for viewing by the public.

According to yet another aspect of the present application, there is provided a method of distributing a multimedia message. The method includes obtaining a wearable multimedia display, attaching the wearable multimedia display to a person, providing a source of multimedia message content accessible to the wearable multimedia display, and displaying the message on the wearable display so that the multimedia message may be viewed by the public.

These and other features of the applicant's teachings are set forth herein.

### DRAWINGS

The skilled person in the art will understand that the drawings, described below, are for illustration purposes only. The drawings are not intended to limit the scope of the applicant's teachings in any way.

FIG. 1 is an exploded view of a wearable multimedia display;

FIG. 2 is a block diagram of a wearable multimedia display;

FIG. 3 is a block diagram of a system for displaying multimedia content on a wearable display;

FIG. 4 is a flow chart illustrating a method for display multimedia content on a wearable display;

FIG. 5 is a flow chart illustrating a method of distributing a multimedia message; and

FIG. 6 is an illustration a person wearing a multimedia display within the view of another person.

### DESCRIPTION OF VARIOUS EMBODIMENTS

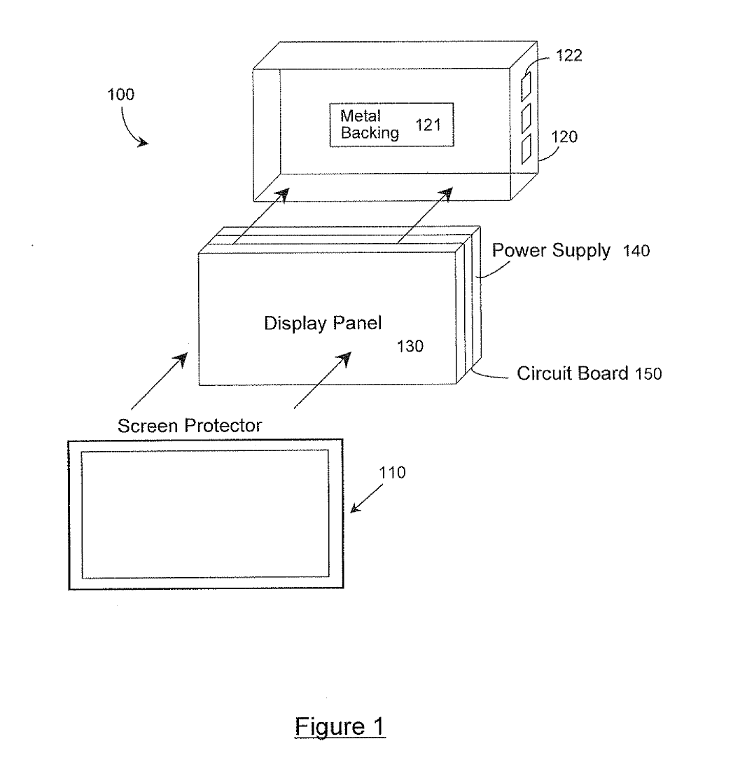

Referring now to FIG. 1, according to some embodiments of the applicant's teachings a wearable multimedia display 100 is shown. The wearable multimedia display has a hollow casing 120 into which a circuit board 150, a display panel 130, and a power supply 140 fit. A transparent screen protector 110 is attached to the hollow casing 120 to enclose the circuit board 150, display panel 130, and power supply 140. The screen protector 110 may be fastened to the hollow casing using, for example, but not limited to, an adhesive, a weld, or screws.

The hollow casing 120 could also have buttons 122 to allow a wearer of the multimedia display to control the function of the display. For example, but not limited to, a power button could be provided to turn the wearable multimedia display on and off, a reset button could be provided to place the wearable multimedia display in an initial state, or a folder selector or media toggle button could be provided to change the multimedia content being displayed.

Also shown in FIG. 1 is a metal backing 121 that allows a wearer to attach the device to their clothing by placing a magnetic bar behind the clothing that is attracted to the backing. Other means for attaching the wearable multimedia display may also be used, for example, but not limited to, an adhesive, a pin, Velcro™, or a clip. In other embodiments, the display may have a neck strap to hang the display from the wearers' neck.

In some embodiments the display panel 130 may be an organic light emitting display (OLED). An OLED is suitable due to its brightness, wide viewing angle, and low power requirements. However, the display panel could use any suitable display technology capable of displaying multimedia content, such as a liquid crystal display (LCD), a thin film transistor LCD, a phosphorescent OLED, a transparent and top-emitting OLED, or a flexible OLED. The display panel 130 should be chosen to have an adequate resolution and colour palette to display multimedia content. In other embodiments, the display panel may be replaced by a holographic projector that projects an image 10 to 20 cm in front of the device.

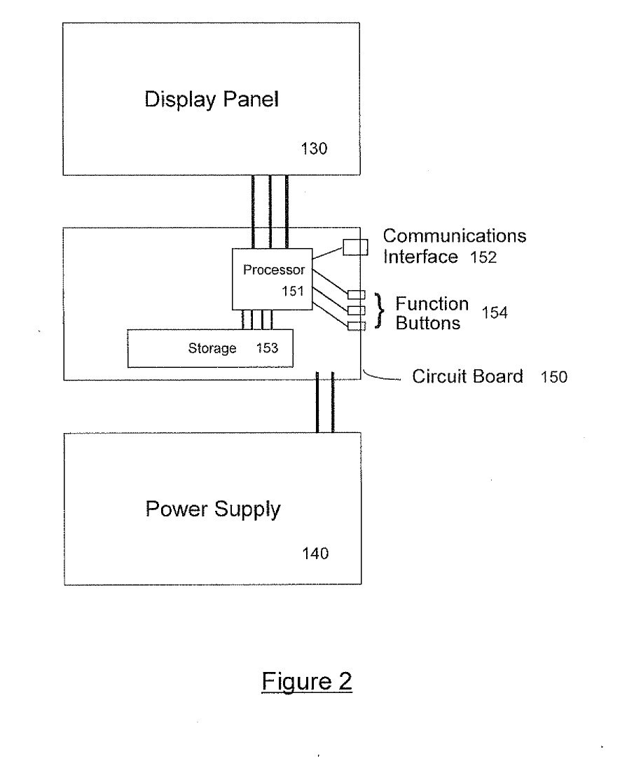

Reference is now made to FIG. 2, which shows a block diagram illustrating the connection between components of the wearable multimedia display. The circuit board 150 has a processor 151 that is connected to the display panel 130. The processor controls the display of multimedia messages on the display, and in some embodiments, may control how the multimedia content is cycled and how long each multimedia message is displayed. In other embodiments, the processor may control transition effects between displaying different multimedia content, for example, but not limited to, fading a message in or out, zooming in and out of the image, rotating an image, or having the image wipe across the display.

The processor 151 may be a general-purpose microprocessor or a processor specifically designed for multimedia applications. Processors that are specifically designed for multimedia applications may have modules to allow the processor 151 to decode audio, video, and images in various standards, for example, but not limited to, AVI, MP3, MP4, GIF, or JPG. The processor may also be specifically adapted to interface with a display panel and may also contain modules supporting various communication protocols. The processor should be capable of controlling, for example, but not limited to, the display of images and video on the display panel 130. Audio may also be controlled by the processor 151 if desired.

In some embodiments the processor 151 may keep track of the date and time to implement a clock or a calendar function. This could allow the wearable multimedia display to act as an alarm or to display a specific multimedia message at a specific time or date. This functionality may allow a multimedia display worn by a fast food service employees to display promotions on the for breakfast items up until 10:30 AM on weekdays and up until 11:00 AM on weekends.

The processor 151 is capable of retrieving multimedia content from a source of multimedia content. In some embodiments, the source of the multimedia content may be storage local to the multimedia wearable display such as storage 153 connected to the processor 151. The storage 153 may be implemented as a non-volatile rewriteable memory, such as flash memory. In other embodiments the storage could also be removable such that the circuit board 150 has a slot for accepting memory. For example, the multimedia wearable display could accept memory cards in SD, microSD, Memory Stick™, or other known formats. This allows the storage to be upgraded to a desired amount of space. The storage could also be implemented using a hard drive.

In other embodiments, the source of the multimedia content may be stored on a computer or multimedia server external to the wearable multimedia display. FIG. 2 shows a communication interface 152 connected to the processor 151 to allow the processor to communicate with the external source of multimedia content. The communication interface 152 can be wired or wireless.

In embodiments where the communications interface is wired, the wearable multimedia display can connect to an external computer or multimedia server so that the processor 151 can transfer multimedia content from the external source to storage 153. In some embodiments the wearable multimedia display may be connected through a USB interface, by a cable or docking station, connected to a personal computer in order to transfer multimedia content to the wearable display. Other wired communications protocols or means may be used, for example, but not limited to, IEEE 802.3, IEEE 1394, or a serial cable.

If the communications interface is wireless, the processor 151 can connect to an external source to either store multimedia content to storage 153 or to stream the multimedia directly from the external source to the display panel 130. The wireless communications interface may be implemented as IEEE 802.11(WiFi), IEEE 802.16 (WiMax), Bluetooth, or infrared. The wireless communications interface may also be implemented using cellular telephone protocols such as CDMA, W-CDMA, GPRS, EDGE, 1xEV-DO, HSDPA or any other next generation technology capable of transmitting multimedia content.

The circuit board 150 receives and conditions power from a power supply 140 for powering the display and components on the circuit board. In some embodiments, the power supply may be implemented as a battery, such as a rechargeable lithium ion battery that can be charged when the wearable multimedia display is connected to the USB interface. Other implementations could use traditional alkaline batteries that can be replaced. The power supply could also consist of a combination of a battery and a solar panel on the exterior of the display.

In other embodiments, the power supply could be located remotely from the display panel 130 and circuit board 150. For example, the wearer could place the power supply in a pocket and have a wire to connect the power supply to the circuit board 150.

Alternatively, the circuit board 150 and power supply 140 could be enclosed in their own casing and carried in a pocket with a wire to connect to the display panel 130. This arrangement would allow the display panel 130 to be constructed using a flexible OLED panel that could adhere to shape of the body.

The circuit board 150 may also have function buttons 154 that are connected to the processor 151. The function buttons 154 may be activated by corresponding buttons 122 on the hollow casing 120. The function buttons 154 allow the wearer of the multimedia display to control the multimedia display. For example, one of the function buttons 154 could be a power button to turn off the multimedia display when not in use. Another function button could allow the wearer to reset the wearable multimedia display to an initial state.

Another one of the function buttons 154 could be a media toggle or folder selector button that allows the wearer to cycle through and select a particular multimedia message to display from the source of multimedia content. Alternatively, the storage 153 could be logically partitioned, for example, but not limited to, by having a number of folders each containing different multimedia content, whereby the media toggle or folder selector button could select the logical partition or folder from which to display multimedia content.

As an alternative to functional buttons 154, the multimedia wearable display could be controlled with a touch sensitive display panel. Touching the display panel would cause the display panel to show a menu that the wearer can navigate using their finger or a stylus. The wearable multimedia display may also invite the viewer to touch the display to interact with the device.

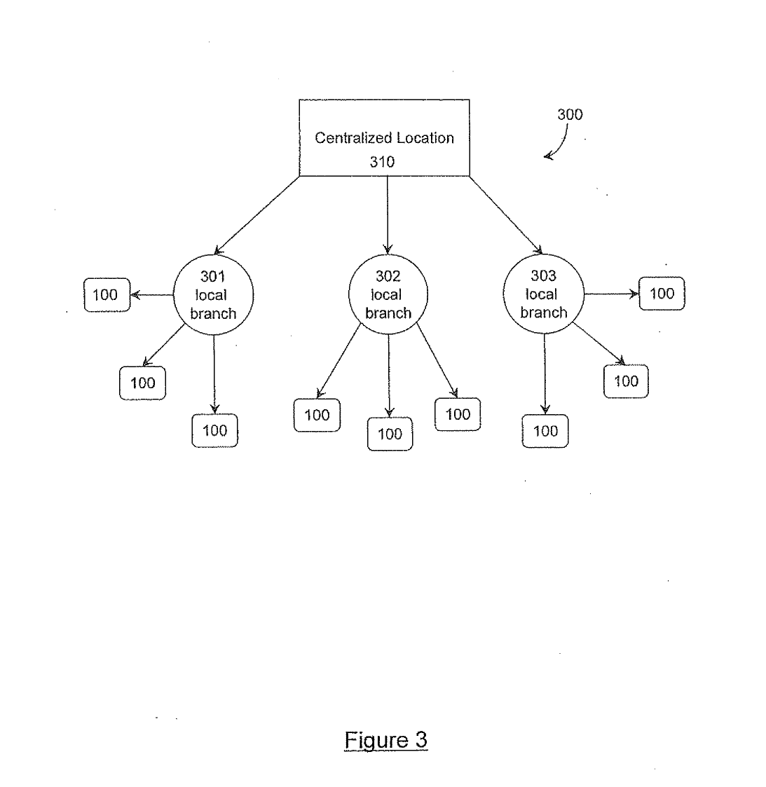

FIG. 3 shows a system 300 for distributing a multimedia message using wearable multimedia displays. A centralized location 310 can act as a central source of the multimedia content. The multimedia content is transmitted from the centralized location 310 to each of the local branches 301-303. In some embodiments, the centralized location 310 could be a server connected to the Internet in order to distribute the multimedia content. Alternatively, the centralized location could distribute the multimedia content on a tangible media, such as CD-ROM, DVD, a card containing flash memory, or an external hard drive. In other embodiments, the centralized location may also distribute the multimedia content over a wireless network either to the local branch or, in the case of a cellular telephone network, directly to the wearable display.

At the local branches, the received multimedia content is then transferred to the wearable multimedia displays 100 through the communications interface 152 as described above. This system allows the centralized location to provide the same message to all local branches in order to coordinate advertising or informational messages across all local branches 301-303. The centralized location 310 could be the head office of a retail chain that has a number of local branches.

Alternatively, the system could also function without the centralized location 310. In this embodiment, the local branches store the multimedia content that is to be transferred to the wearable multimedia display 100.

Other embodiments of the system could incorporate wearable multimedia displays that have a Radio Frequency Identification (RFID) chip. The RFID chip could for example, but not limited to, allow the location of the display to be tracked, so as to monitor employee activity, or for the display to trigger different advertisements based on a location within a local branch.

In some embodiments of the system, either the local branch or centralized location may run software to resize images and video to the proper resolution of the display panel of the wearable multimedia device. The software may also convert images and video into a format that can be handled by the processor of the multimedia display.

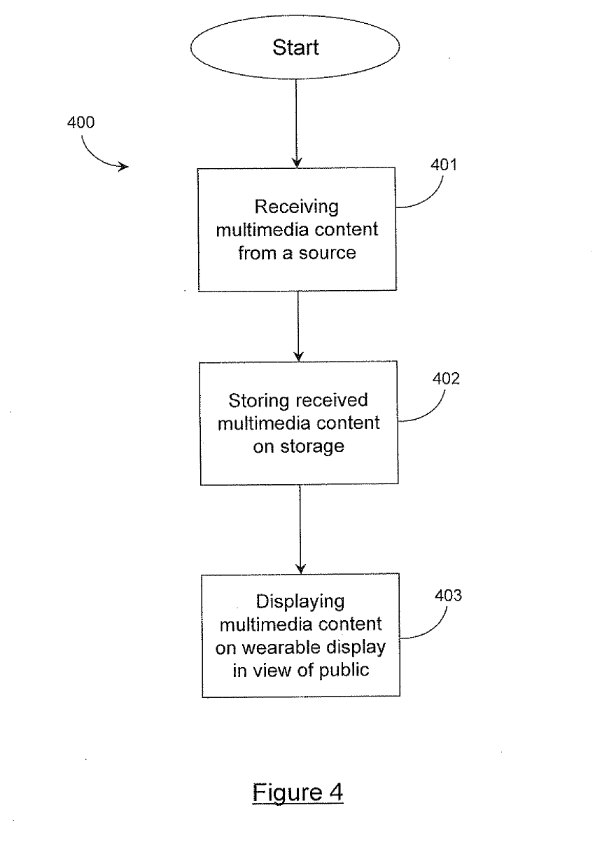

Referring now to FIG. 4, shown is a method 400 of displaying multimedia content on a wearable display. In step 401, multimedia content is received from a source of multimedia content by the wearable multimedia display. In some embodiments, as shown in step 402, the received multimedia may be stored in a storage element of the multimedia display. Finally, in step 403, the received multimedia may be displayed on a display panel of the wearable multimedia display in view of the public.

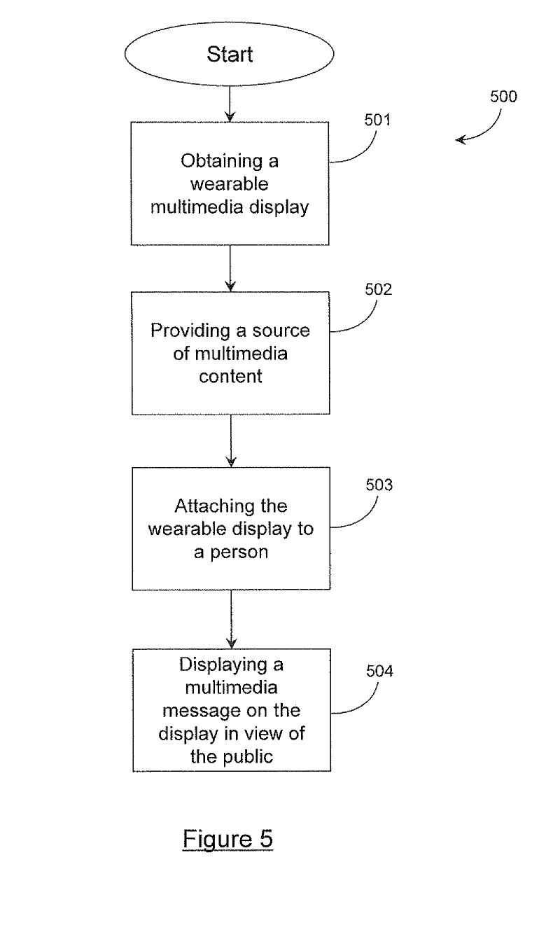

Referring now to FIG. 5, shown is a method 500 of distributing a multimedia message using a wearable multimedia display. In step 501, at least one wearable multimedia display is obtained. The wearable multimedia display should have a display panel with an adequate resolution for displaying multimedia content.

A source of multimedia message content is provided in step 502. The source of multimedia message content is accessible to the wearable multimedia display. The source of multimedia content may include, but is not limited to, advertisement or information.

In step 503, the wearable multimedia display is attached to a person in such a manner that people in the vicinity of the multimedia display may view the display panel. The multimedia message is then displayed on the wearable multimedia display in view of the public in step 504.

The multimedia message that is displayed may be an image, for example, but not limited to, a name of the person wearing the display, the company name, an advertisement, or promotion. The multimedia message may also be a slideshow of the previously mentioned images. Full motion video of an advertisement or promotion may also be a multimedia message that may be distributed.

The method of distributing a multimedia message using a multimedia display may be used in a number of different contexts by altering the multimedia message. In an embodiment where the message is distributed in retail sales outlets, the multimedia message may consist of, but is not limited to, images or video showing the following: name of the employee, the company name, advertisement or promotions for the stores products or services, or affiliate marketing.

In other embodiments, the method of distributing a multimedia message may be used in the service industry, such as food and restaurant services, banking services, health and dental services, or the casino gaming industry. As an example in the restaurant service industry, a waiter or waitress wearing a multimedia display may promote the day's special or a particular dish or drink. In the fast food services, a fast food employee wearing a multimedia display may display a multimedia message up selling the customer to a larger size or a 2-for-1-dessert promotion. In the banking industry, a teller may wear a multimedia display to advertise financial services, such as a special interest rate or a new account type. A wearable multimedia display may also be worn by casino workers to promote specials on rooms and food, or to display gaming instructions, such as betting limits.

In another embodiment, the multimedia message may be distributed to conference attendees where the multimedia message may consist of, but is not limited to, images or video showing the following: a greeting or introduction with the attendee's name, biographical information of the attendee, that attendee's company name, promotional advertising from the attendee's company, or the attendee's schedule.

In yet another embodiment, the method of distributing a multimedia message may be used to generate advertising revenue by selling advertising space and time on the multimedia display. For example, but not limited to, a video rental store or movie theatre with employees wearing multimedia displays, the store or theatre may selling advertising space to candy or soda manufacturers to promote their products, or to movie distributors to present a short trailer of an upcoming or new release movie.

In still another embodiment, the multimedia message may be distributed to players of a live game where the multimedia message may consist of, but is not limited to, images or video showing the following: the player's name, the player's team name, the player's status in the game, or the player's current score.

In yet another embodiment, the multimedia message may be distributed to provide instructions or information. For example, but not limited to, a message instructing people to go to a certain location, directions to a location, or to perform a certain task. Informational messages may include images or video showing the date, the time, a countdown of time remaining, the weather, room temperature, or the status of financial markets or particular stocks.

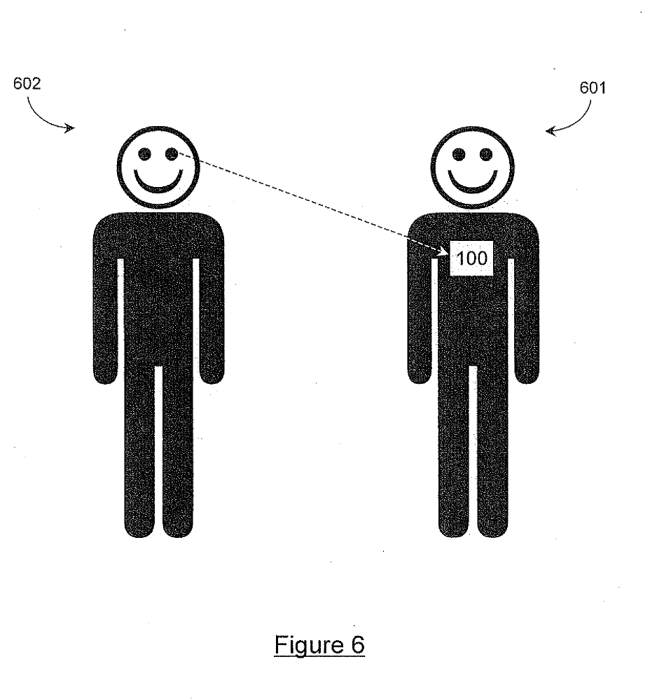

FIG. 6 shows a first person 601 wearing the wearable multimedia display within the view of a second person 602. The first person 601 is wearing a multimedia display 100 on, for example, but not limited to, their chest so as to be in view of the second person 602.

While the applicant's teachings are described in conjunction with various embodiments, it is not intended that the applicant's teachings be limited to such embodiments. The applicant's teachings encompass various alternatives, modifications, and equivalents, as will be appreciated by those of skill in the art.

1. A wearable multimedia display comprising:
a display panel adapted to display multimedia content;
a processor, connected to the display panel, the processor to control the display of multimedia content from a source of multimedia content; and
means for attaching the display to a wearer.

2. The wearable multimedia display of claim 1, further comprising a communication interface connected to the processor, the communication interface to retrieve multimedia content from the source of multimedia content.

3. The wearable multimedia display of claim 2, wherein the communication interface is wired.

4. The wearable multimedia display of claim 2, wherein the communication interface is wireless.

5. The wearable multimedia display of claim 4, wherein the processor streams multimedia content from the source of multimedia content through the wireless communication interface.

6. The wearable multimedia display of claim 1, wherein the source of multimedia content contains a plurality of multimedia content, the wearable multimedia display further comprising a selector button that allows the wearer to select one of the multimedia content from the source of multimedia content.

7. The wearable multimedia display of claim 6, wherein the processor cycles through the multimedia content, displaying the multimedia content for a predetermined time.

8. The wearable multimedia display of claim 1, wherein the source of multimedia content is flash memory.

9. The wearable multimedia display of claim 1, wherein the source of multimedia content contains video.

10. The wearable multimedia display of claim 1, wherein the source of multimedia content contains images.

11. The wearable multimedia display of claim 1, wherein the display panel is an organic light emitting display.

12. The wearable multimedia display of claim 1, wherein the display panel is a liquid crystal display.

13. The wearable multimedia display of claim 1, wherein the means for attaching is selected from the group consisting of: a magnetic backing, an adhesive, Velcro, a pin, a neck strap, and a clip.

14. The wearable multimedia display of claim 1 further comprising a power supply.

15. The wearable multimedia display of claim 14, wherein the power supply is a rechargeable lithium ion battery.

16. A system for displaying a multimedia message on a wearable display comprising:
a source of multimedia content;
at least one wearable display device having a display panel, the display panel adapted to display multimedia content, and a communications interface connected to the source of multimedia content; and
a processor connected to the display panel, the processor to control the display of multimedia content received from the source of multimedia content.

17. The system of claim 16, wherein the source of multimedia content is a central location remote from the wearable multimedia display.

18. The system of claim 16, wherein the communication interface is wired.

19. The system of claim 16, wherein the communication interface is wireless.

20. The system of claim 16, wherein the processor streams multimedia content from the source of multimedia content through the communication interface.

21. The system of claim 17, wherein the source of multimedia content contains video.

22. The system of claim 17, wherein the source of multimedia content contains images.

23. The system of claim 17, wherein the display panel is an organic light emitting display.

24. The system of claim 17, wherein the display panel is a liquid crystal display.

25. A method of displaying a multimedia message on a wearable display, the method comprising:
receiving multimedia content from a source of multimedia content; and
displaying the multimedia content on a display panel of the wearable display, the display panel adapted to display multimedia content, so that the multimedia content is accessible for viewing by the public.

26. The method of distributing a multimedia message on a wearable display further comprising storing received multimedia content on a storage element of the wearable display.

27. A method of distributing a multimedia message comprising:
obtaining at least one wearable multimedia display;
attaching the at least one wearable multimedia display to a corresponding at least one person;
providing a source of multimedia message content accessible by the at least one wearable multimedia display; and
displaying the multimedia message on the at least one wearable multimedia display so that the multimedia message may be viewed by the public.

28. The method of claim 27, wherein the multimedia message is advertising or promotional material directed towards potential customers.

29. The method of claim 27, further comprising selling advertising space to display a multimedia message on the at least one wearable multimedia display.
